(19) United States
(12) Patent Application Publication
(10) Pub. No.: US 2026/0071704 A1
(43) Pub. Date: Mar. 12, 2026

(54) A TUBE CONNECTOR AND ASSOCIATED TOOL

(71) Applicant: RELIANCE WORLDWIDE CORPORATION (UK) LIMITED, West Drayton, Middlesex (GB)

(72) Inventor: Glen ANSELL, Edgware, Middlesex (GB)

(21) Appl. No.: 19/104,572

(22) PCT Filed: Jul. 14, 2023
(86) PCT No.: PCT/GB2023/051860

§ 371 Date: Feb. 18, 2025

(30) Foreign Application Priority Data
Aug. 25, 2022 (GB) 2212367.3

(51) Int. Cl. F16L 37/091

(52) U.S. Cl. CPC F16L 37/0915

(57) ABSTRACT

A tube connector 20 comprising a body 21 with an open proximal end to receive a tube T. An O-ring 26 seals on the wall of the tube T. A collet 25 comprises a collet ring 27 at a distal end of the collet 25. A plurality of resilient collet legs 28 extend proximally from the ring 27, the legs having teeth 31 to grip a tube T. A cap 23 is fitted to the body 21 to retain the collet 25. The cap 23 has an opening to allow entry of the tube T and a cap angle 33 to push the teeth 31 into engagement with the tube when the tube is moved proximally. A release tool 40 for the connector 20 can be inserted distally into the connector to deflect the collet legs 28 away from the tube T.

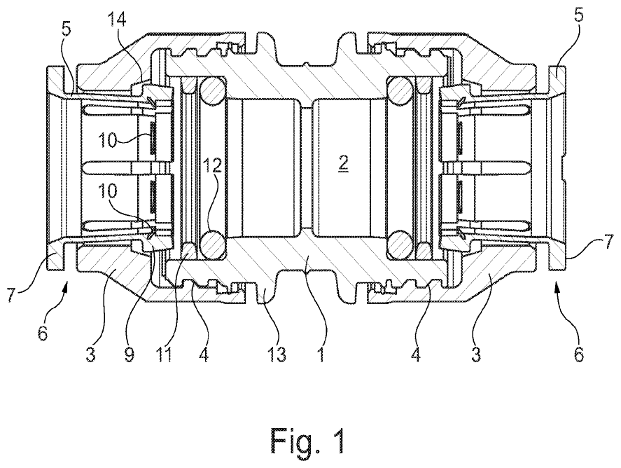

The present disclosure relates to a tube connector to receive and secure and tube. The connector is primarily designed as a plumbing connector, but may be used in any situation where it is desirable to retain a tube, for example, for an air/gas or cable. In particular, the disclosure relates to an adaptation of our known Speedfit® connector as shown in FIG. 1.

This shows a connector with a hollow body 1 with an axial through bore or passage 2. On at least one proximal end of the body 1 is a cap 3 which is screwed onto the body 1 by complimentary screw thread 4. A collet 5 passes through the end cap 3 so as to be exposed at an open end 6 of the connector. The collet 5 comprises a collet ring 7 which is exposed at the open end 6 and a plurality of resilient legs 8 that extend into the cap 3 where they each terminate at an enlarged head 9, the inner face of which has a gripping tooth 10. A spacer ring 11 is provided distally of the collet 6 to retain the O-ring 12 in place to separate this from the collet 5.

When a tube is placed into this connector, the end caps 3 are screwed down from the position shown in FIG. 1 until they abut or are otherwise adjacent a shoulder 13 on the body 1. In this position, the cap inhibits axial movement of the collet in at least one direction, such as the axial direction). In this configuration, any attempt to remove the tube from the connector will cause the teeth 10 to bite into the tube and this forces the head 9 of the collet against a cap angle 14 in the cap 3 such that the teeth 10 bite progressively harder into the tube. This helps to reduce the likelihood of inadvertent removal of the tube.

In order to release the tube, the cap 3 has to be screwed into the position shown in FIG. 1. The user can then hold the collet 5 in an inward position by applying proximal axial pressure to the collet ring 7. This will prevent the teeth 10 from gripping the tube allowing it to be withdrawn from the connector.

A simpler version of this design is known in which the cap is fixed with respect to the body. In this case, in order to remove the tube, it is simply necessary to hold the collet down as previously described in order to remove the tube.

These connectors have been very successful, largely because of the simplicity of engaging, gripping and releasing the tube as described above.

However, the simplicity of the connector does deter use of the connector in some circumstances as some plumbers or installers do not trust the simple demount operation. Instead, they may prefer a connector which requires a tool in order to disengage the connector. The requirement for a tool also has a security benefit in that it can prevent the connection from being released unless the person doing the releasing has the appropriate tool.

CN105972359 discloses a connector which uses a split ring ferrule rather than a collet with a collet ring with a plurality of resilient legs to grip the tube. Gripping of the tube is therefore done by a pair of axially spaced split annular teeth.

FR2590648 discloses a connector with a clamp in which the jaws of the clamp bear against an inclined face on the body to urge them to grip a pipe in the connector. A cap is fitted over the body and has an inclined face which, upon moving the cap into the connector pushes the jaws away from the pipe to release the pipe.

A product produced by Hepworth as part of their BiTite range uses a collet in an inverted configuration. This has an end cap which is screwed onto a body which keeps the O ring and collet in place. In order to unlock the connector, it is necessary to fully unscrew the cap. This is awkward to do in practice. Once the cap is removed there is nothing to keep the O ring and collet in place such that they can fall out of the connector or become misaligned within the connector.

A similar connector with an inverted collet is shown in EP0863356. This again has a removable end cap which has to be removed to unlock the connector. It has a spacer ring extending into the body to support the O ring. The collet is then received within the spacer ring.

According to the present disclosure, there is provided a tube connector to receive and secure a tube, the connector comprising a body with a throughway with an open proximal end to receive a tube; an O-ring within the throughway to seal on the tube; a collet comprising a collet ring at a distal end of the collet and a plurality of resilient collet legs extending proximally from the ring, the legs having teeth to grip, in use, a tube in the connector; a cap fitted to the body to retain the collet, the cap having an opening at the open end to allow entry of the tube and having a cap angle configured to cooperate with the collet legs to push the teeth into engagement with the tube, in use, when the tube is moved proximally; wherein the opening in the cap has at least one recess to allow insertion, in use, of a release tool in a distal direction between the tube and cap to deflect the collet legs away from the tube.

The collet is in the opposite orientation as compared to a conventional connector. As a result of this, it is not possible to hold the collet teeth away from the tube by pressing upon an exposed part of the collet as described above.

By using a collet with a collet ring with a plurality of resilient legs to grip the tube, the connector has a fundamentally different gripping arrangement than CN105972359.

By providing a cap angle on the cap to push the teeth towards the tube, the connector is fundamentally different from FR2590648 which instead uses the cap to provide a release mechanism.

Unlike the Hepworth connector and the connector in EP0863356, the tube can be released by insertion of a release tool. This means that the tube can be removed without effectively dismantling the connector. This is a simpler operation and removes the possibility of the internal components being lost, damaged or displaced.

Thus, in order to release the connector, it is not simply a matter of pushing on the end of the connector. Instead, the separate tool is required to be inserted into the connector. This provides a tamper proof benefit in that a special tool is required to disconnect the connector. It also allows the design of the connector to be simplified. Effectively, the prior art connector requires each connector to be permanently provided with its own release mechanism. In the present example, the release mechanism is not integrated into the connector. Rather, the release mechanism is provided by a separate tool and a single tool can be used to disengage multiple connectors.

The cap may be captive on the body. This means that the cap will not be dislodged from the body by applying normal operational forces. Further the connector is intended to be operated at all times with the cap in place on the body. There is no need to remove the cap from the body to release the tube. It may still be possible to remove the cap from the body, but this requires a force well in excess of the normal operational force and is not required for normal operation. This prevents removal of the cap in normal operation thereby avoiding problems with the connector being inadvertently disassembled.

The connector may be provided with the spacer ring of the prior art in order to support the O-ring. However, one of the benefits of inverting the orientation of the conventional collet is that the collet ring is now at the end facing the O-ring. As such, the collet ring may limit the movement of the O-ring. This allows one of the components of the prior art to be eliminated.

As described above, the prior art locking mechanism firstly requires rotation of the cap in order to allow the collet to be held away from the tube. This provides some protection against accidental release of the tube. However, now that the collet is not configured to be released by external axial pressure, it cannot be accidently dislodged. As such, there is no need for the cap to provide a rotatable locking sleeve. In one example, therefore, the cap is axially fixed with respect to the body. Again, this simplifies the structure of the connector as the screw threaded connection between the cap and body can be eliminated. This allows the connector to have a lower profile design. In other examples, the rotatable cap can be retained, particularly, to allow the present disclosure to be used in conjunction with the existing body.

When the cap is axially fixed with respect to the body, there is generally less space to allow the teeth to be held away from the tube by the tool. This can be achieved by providing a relatively large radial clearance between the collet and the cap angle. However, this can compromise the ability of the cap angle to fulfil its function. Therefore, the collet may be axially moveable when, in use, the collet receives a tube and is in a fully engaged position. In this case, when the tube is moved proximally, the engagement between the teeth and the tube will pick up the collet and move this proximally in order for the cap angle to come into effect. When the tool is inserted, as well as deflecting the collet legs radially outwardly, this can also urge the collet in a distal direction thereby keeping the legs away from the cap angle and allowing sufficient clearance for radial outward deflection of the collet legs.

The collet may extend proximally of the cap. However, if the cap extends proximally beyond the collet the collet may be fully contained within the cap. This provides protection against accidental movement of the collet.

The collet may extend into the cap. This helps with allowing the collet ring to limit the movement of the O ring.

The collet ring may be a continuous ring. The cap may only have a single cap angle. The only teeth may be at the proximal end of the collet. Each collet leg may have an enlarged head which engages, in use, with the cap angle.

The collet ring may project radially outwardly with respect to the collet legs. This provides a feature which allows the collet to be retained squarely within the body, while allowing the legs to be thinner and therefore more able to deflect to allow release of the tube.

The disclosure also extends to a combination of a tube connector and a release tool, the release tool being insertable into the connector in a distal direction between the tube and cap to deflect the collet legs away from the tube.

The release tool may be a single piece fitted into one side of the connector, or may be made of several parts separately fitted into the connector. In one example, it may have a split ring configuration, with sufficient resilience for the tool to be fitted in a radial direction over the tube before being moved axially into the connector. This allows the tool to be a single piece and to be fitted laterally over the tube extending from the connector and then axially into the connector in a manner in which it extends around a substantial portion of the connector and can therefore engage with multiple parts of the collet.

The release tool may have a radially extending flange portion providing a bearing surface via which a user can, in use, push the tool axially into the connector and an engagement portion extending axially from the flange to enter the connector. This allows for easy manipulation of the tool. As this flange is not permanently part of the connector it can be much bigger than the exposed part of the collet which needs to be depressed to release the conventional connector.

The engagement portion may comprise a plurality of engagement elements or features, such as engagement prongs, arranged circumferentially, and wherein the connector requires each of the engagement elements to be inserted in order to allow release of the tube. This provides a connector which cannot simply be released by placing a single blade, or some other suitable item, into one side of the connector.

In an unstressed state and at its greatest or outermost circumferential extent, the tool may extend through an angle of at least 270 degrees in one example configuration. In additional or alternative configurations, the angle may be at least 280 degrees, at least 290 degrees, at least 300 degrees, at least 310 degrees, at least 320 degrees, at least 330 degrees. This helps it to surround a significant part of the connector.

The tool may have a chamfered end face which is complementary with a chamfered end face of the collet legs. This helps it to fit within the collet.

The disclosure also extends to a release tool for a connector, the tool having a split ring configuration surrounding a central opening, wherein in an unstressed state and at its greatest circumferential extent the tool extends through an angle of at least 270 degrees, defining a gap in the split ring, the tool having sufficient resilience that the gap can be widened to at least the diameter of the central opening; wherein the release tool has a radially extending flange portion providing a bearing surface via which a user can, in use, push the tool axially and an engagement portion comprising a plurality of engagement elements arranged circumferentially and extending axially from the flange. In additional or alternative embodiments, the angle may be at least 280 degrees, at least 290 degrees, at least 300 degrees, at least 310 degrees, at least 320 degrees, at least 330 degrees The flange may have a plurality of through slots positioned circumferentially between the engagement elements and extending radially outwards from the inner periphery of the flange. This helps make the tool more flexible so that it can deform to fit over the tube.

The diameter of the flange may be at least twice the diameter of the central opening. This provides a large engagement surface for the user to push on.

The tool may have a chamfered end face which is complementary with a chamfered end face of the collet legs. This helps it to fit within the collet.

Examples of connectors and a tool in accordance with the present disclosure will now be described with reference to the accompanying drawings, in which:

FIG. 1 is a cross-section through a prior art connector;

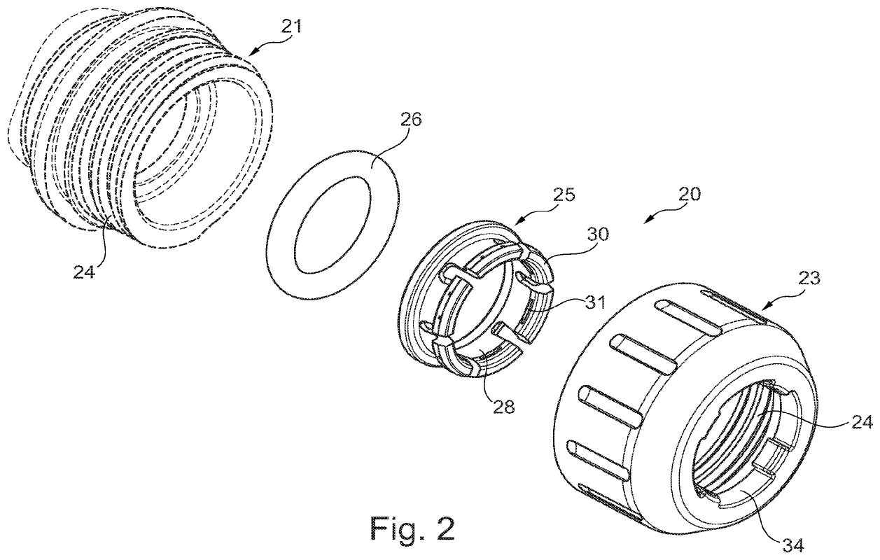

FIG. 2 is an exploded perspective view of a first connector;

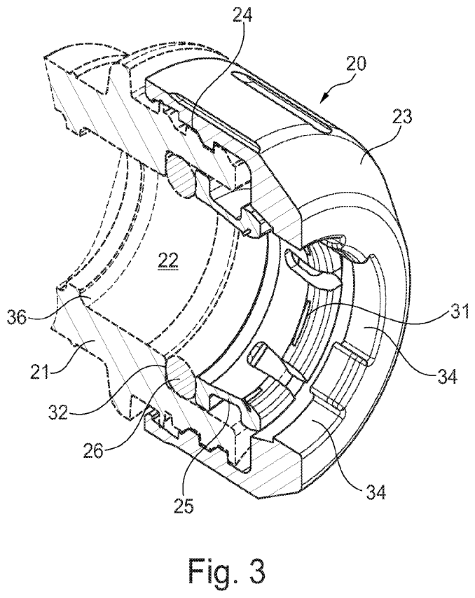

FIG. 3 is an assembled cross sectioned perspective view of the first connector in an unlocked configuration;

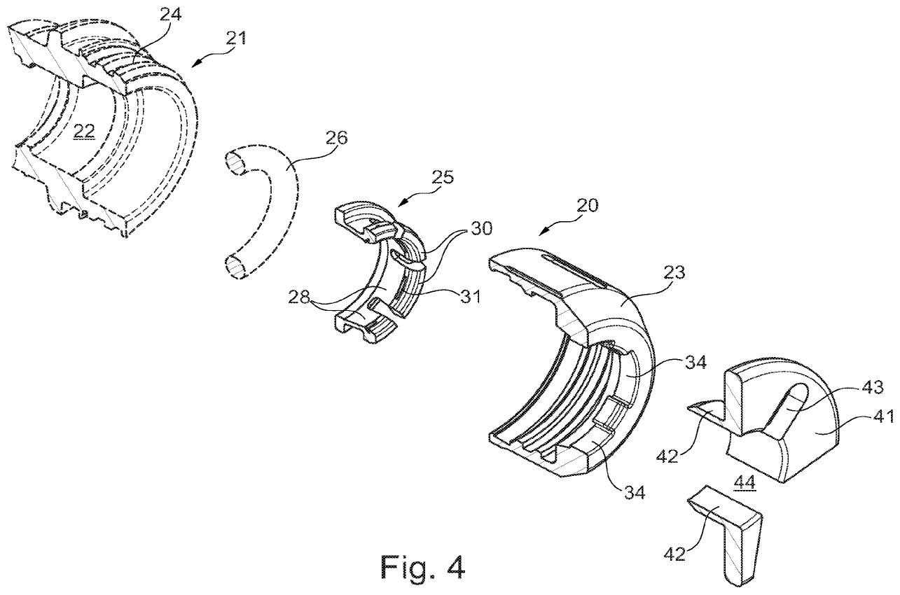

FIG. 4 is an exploded cross sectioned perspective view of the first connector and the tool;

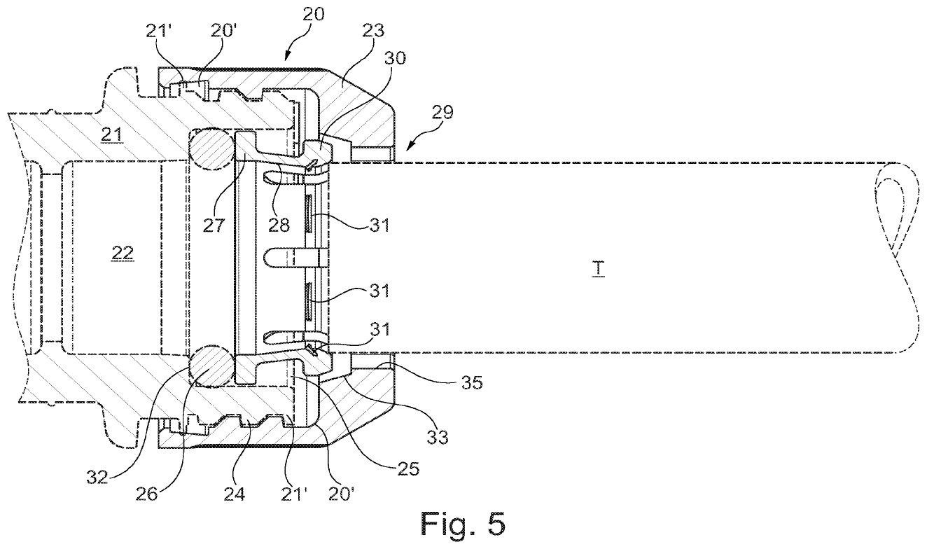

FIG. 5 is a partial cross-section through the first connector in the unlocked configuration and also showing the tube;

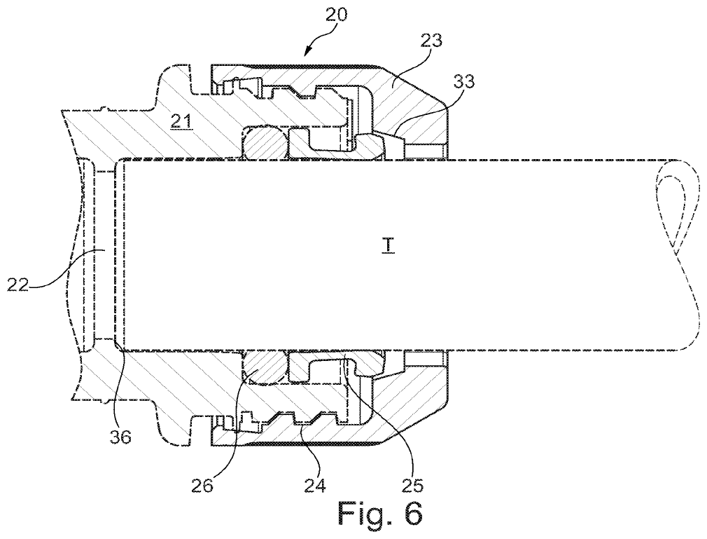

FIG. 6 is a view similar to FIG. 5 with the tube inserted into the connector;

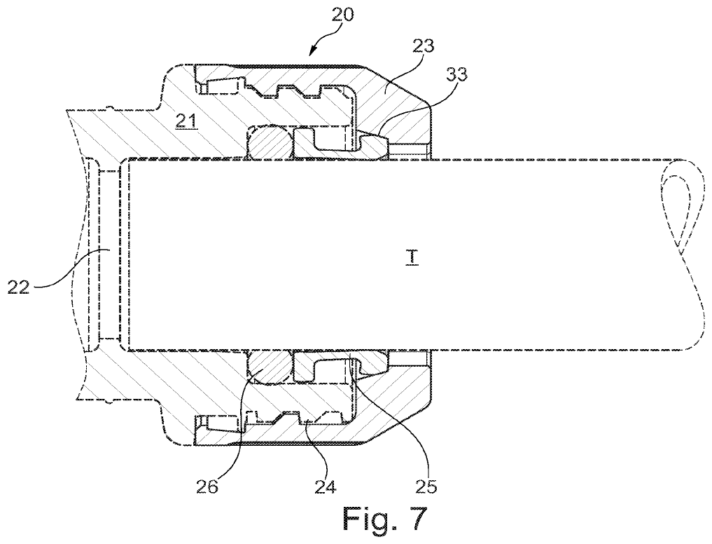

FIG. 7 is a view similar to FIG. 6 in the locked configuration;

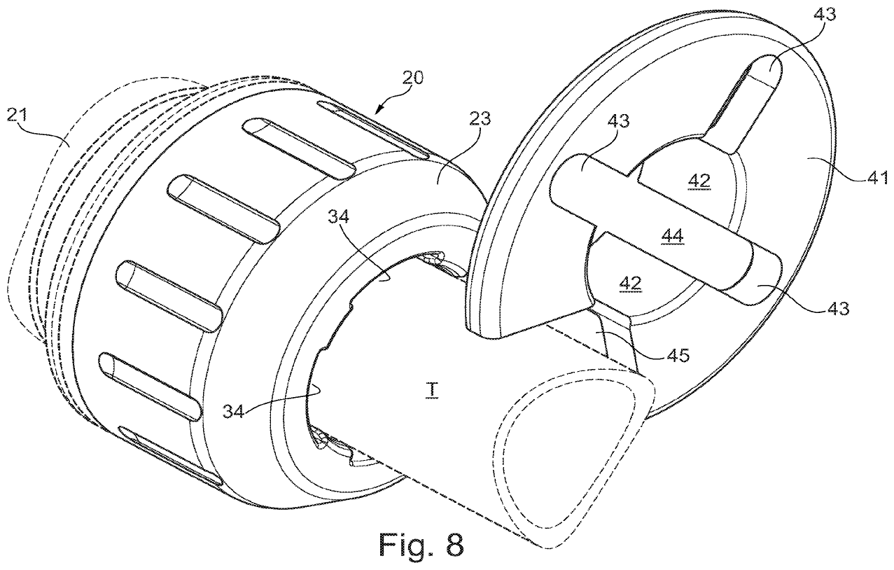

FIG. 8 is a perspective view of the first connector with the tube inserted and showing the tool in the pre-engaging position;

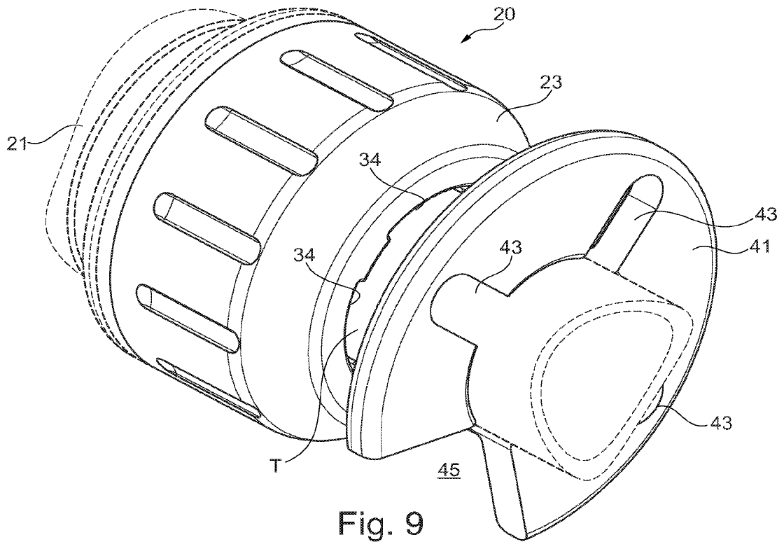

FIG. 9 is a view similar to FIG. 8 showing the tool partially engaged;

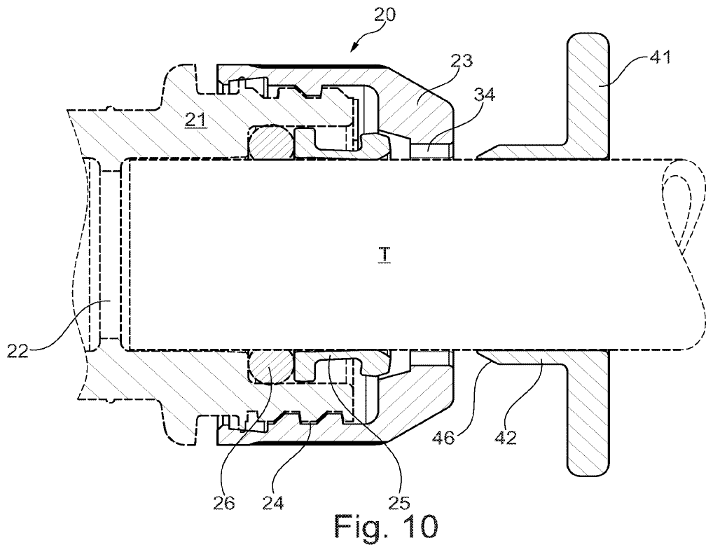

FIG. 10 is a cross-sectional view of the arrangement shown in FIG. 9;

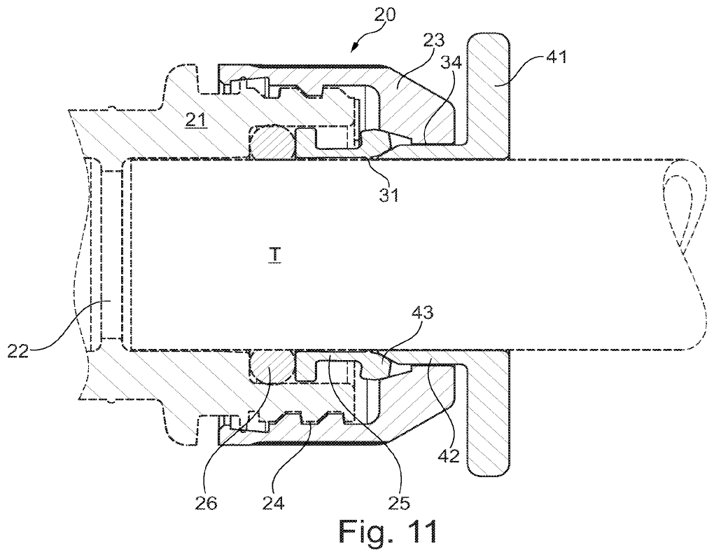

FIG. 11 is a view similar to FIG. 10 with the tool showing fully inserted into the connector;

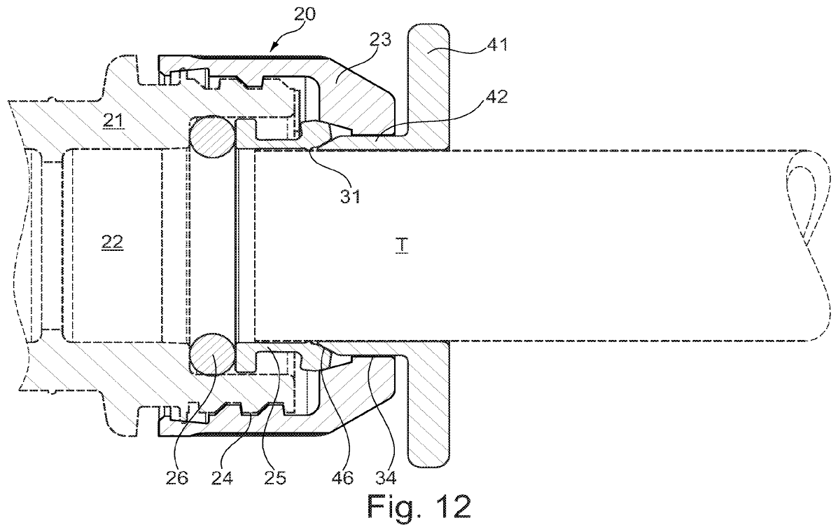

FIG. 12 is a view similar to FIG. 11 with the tube partially removed from the connector;

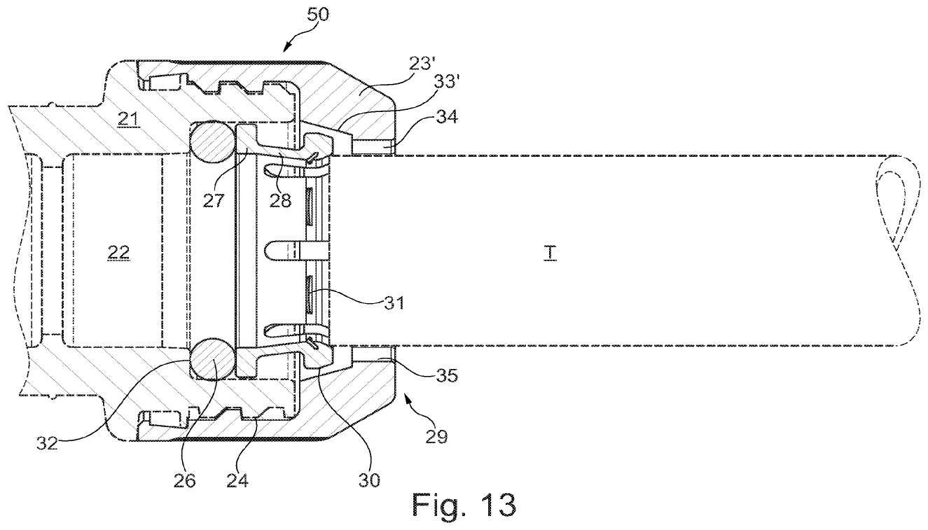

FIG. 13 is a view similar to FIG. 5 of a second connector and the tube;

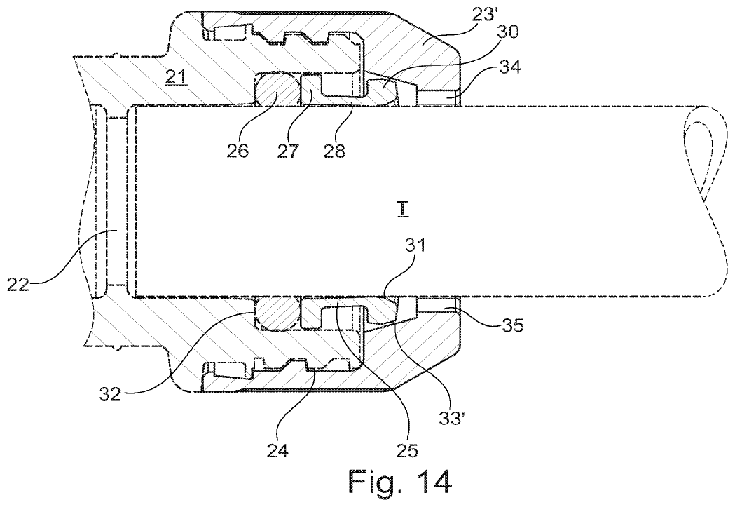

FIG. 14 is a view similar to FIG. 7 of the second connector;

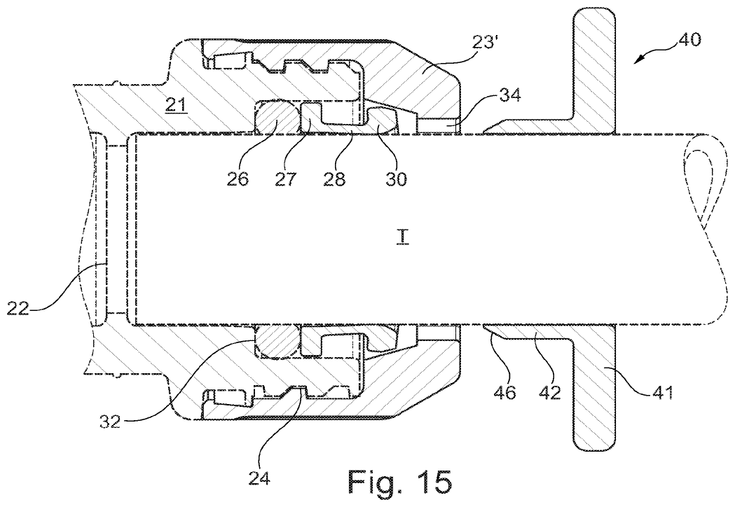

FIG. 15 is a view similar to FIG. 10 of the second connector;

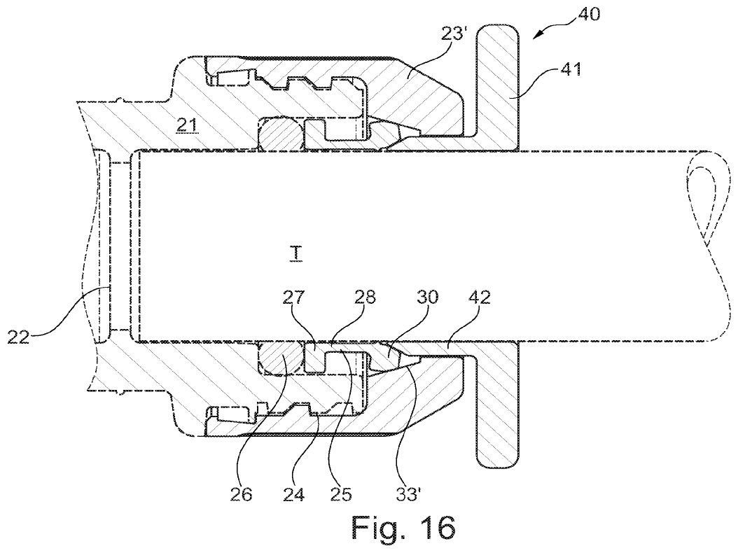

FIG. 16 is a view similar to FIG. 11 of the second connector;

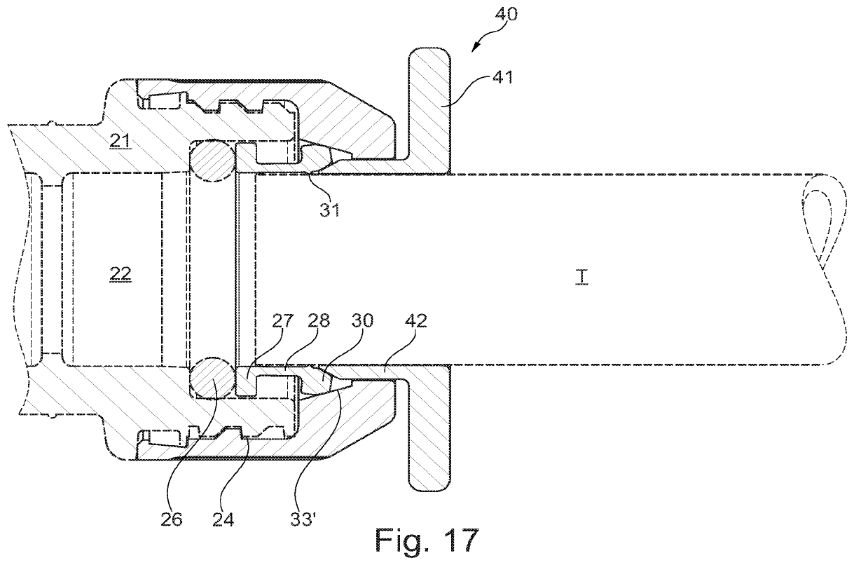

FIG. 17 is a view similar to FIG. 12 of the second connector; and

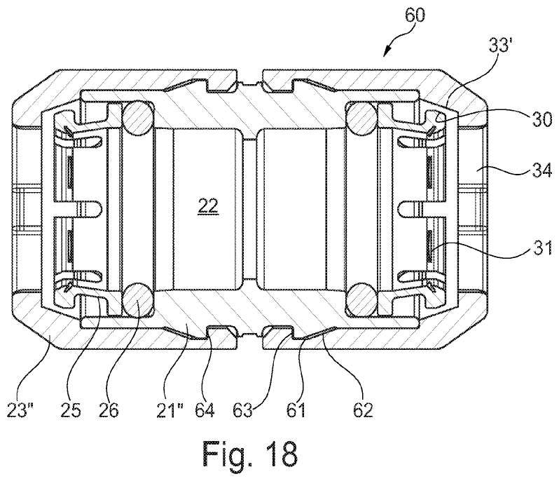

FIG. 18 is a partial cross-section of a third connector.

A first example of a connector will now be described with reference to FIGS. 2 to 12.

The specification references proximal and distal ends and directions. The proximal end is the open end of the connector and the distal end is the end furthest from the open end. The proximal direction is the direction from the distal end towards the proximal end, i.e. out of the connector. The distal direction is the direction from the proximal end towards the distal end, i.e. into the connector.

The illustrated connector 20 has only one connection. A similar arrangement may be provided at the opposite end of the connector. Alternatively, the connector may include an elbow, tee, end stop or end, manifold with branches or any other suitable shape or fitting configuration. In other cases, the connector 20 may be provided for one joint and a different type of connector may be used for other joints. As a further alternative, the connector 20 may be part of a larger component and provide a means to connect the larger component to a tube, such as a valve or other plumbing installation or apparatus.

The connector 20 comprises a body 21 with an axial through bore 22. A cap 23 is threaded onto the body 21 via a complementary screw thread 24 and is held captive on the body caused by a flange 21′ on the body engaging is a groove 20′ on the cap 20 (see FIG. 5). A collet 25 is retained within the body 21 and cap 23 and an O-ring 26 is provided to seal with the outer wall of a tube T inserted into the connector.

The collet 25 comprises a collet ring 27 from which a plurality of flexible collet legs 28 extend towards an open end 29 of the connector. Each collet leg 28 has an enlarged head 30 which is provided with an inwardly facing angled tooth 31.

The O-ring 26 is retained between the collet ring 27 and a shoulder 32 formed as part of the through bore 22.

As compared to the conventional connector shown in FIG. 1, it will be appreciated that the collet 25 is positioned the opposite way round with the collet ring 27 innermost. This allows the O-ring 26 to be supported by the collet ring without requiring a separate spacer ring.

The cap 23 extends proximally beyond the collet head 30 so as to fully surround it. The inner face of the cap 23 is provided with a cap angle 33 as described below.

The inner face of the cap 23 at the open end 29 is provided with a number of circumferentially arranged recess 34 around a central opening 35 for insertion of a release tool 40 as described below.

The manner in which the connector 20 is connected to a tube T will now be described with reference to FIGS. 5 to 7.

In order to insert the tube, the cap 23 must be moved to its fully open position to the right shown in FIGS. 5 to 7. In this position, the collet 25 has a significant amount of room to move axially and deflect radially outwardly. With the connector in this position, the tube T is then inserted through the opening 35 as shown in FIG. 5.

The tube T then enters the collet 25 thereby deflecting the legs 28 outwardly to allow the tube T to be inserted past the O-ring 26 until it reaches an end stop 36. This position is shown in FIG. 6. The cap 23 is now screwed down onto the body 21 to the position shown in FIG. 7. As will be appreciated from a comparison of FIGS. 6 and 7, this process moves the end cap 23 axially with respect to the collet 25 into the position shown in FIG. 7 in which the collet is constrained from movement both in the axial and radial directions.

In this configuration, any attempt to remove the tube T by pulling it proximally will cause the angled teeth 31 to grip the wall of the tube. Outward deflection of the collet legs 28 is prevented by engagement of the heads 30 with the cap angle 33 which ensures that the greater the force that is applied to the tube T, the greater the extent to which the teeth 31 grip the tube.

Before describing the release of the tube T, the release tool 40 will be described with reference to FIGS. 4, 8 and 9.

The release tool 40 is a single injection moulded component. It comprises a flange 41 having a generally annular configuration and a plurality of engagement portions 42 which extend axially from the inner edge of the flange 41. Each engagement portion 42 has a generally arcuate cross-section and is complementary with the recesses 34 on the opening 35 in the cap 23. A number of radially extending grooves 43 extend from the innermost edge of the flange 41 most of the way across the flange 31. The grooves 43 coincide with gaps 44 between adjacent engagement portions 42. An open gap 45 is provided through both the flange 41 and engagement portions 42 to give the tool 40 a split-ring configuration.

The manner in which the release tool 40 is used to release the connector will now be described with reference to FIGS. 8 to 12.

As shown in FIG. 8, the release tool 40 is presented to the connector 20 by being moved in a radial direction towards the tube T in the vicinity of the connector 20. The gap 45 is pushed against the tube T and this spreads the ring, aided by the grooves 43. Upon further pushing, the resilience of the release tool 40 causes the tool to move back into its unstressed position as shown in FIG. 9 in which it surrounds the tube T. If necessary, the release tool 40 can then be rotated such that the engagement portions 42 are in alignment with the recesses 34 in the cap 23. This position is shown in FIGS. 9 and 10. Either before or after the attachment of the release tool 40, the cap 23 is screwed back to the unlocked position as shown in FIG. 10.

Once both components are in the correct position, the user presses on the flange 41 causing the engagement portions 42 to enter the recesses 34. The ends of the engagement portions 42 are provided with a chamfer 46 which enters the collet 25 pushing the heads 30 radially outwardly, thereby disengaging the teeth 31 from the tube T as shown in FIG. 11. With the tool in this position, the tube T can now be pulled proximally out of the connector 20 as shown in FIG. 12. While this happens, the tool 40 keeps the teeth 31 away from the tube T. Once the tube T is removed, the release tool 40 can simply be pulled distally out of the connector 20.

A second connector 50 will now be described with reference to FIGS. 13 to 17. Most of the components are the same or similar and are designated with the same reference numeral. The differences between the two examples are described below.

The main difference between the first and second examples is that the second connector 50, can be operated with the cap 23′ in the ‘locked’ position. In other words, there is no need to actuate or move the cap 23 between different positions in order to either insert or release the tube T.

This is apparent from a comparison of FIGS. 5 and 13. In FIG. 5, the cap 23 is unscrewed to allow the tube to be inserted. However, in FIG. 13, the tube T can be inserted even though the cap 23′ is fully screwed onto the body 21.

In order to compensate for this, the cap 23′ is provided with a longer cap angle 33′. This longer cap angle 33′ means that, even though the cap 23′ is fully screwed onto the body 21, there is still enough clearance between the cap angle 33′ and the collet heads 30 for the collet legs 28 to be deflected radially outwardly to allow the insertion of the tube.

The difference in the configuration in the fully locked positions in the two examples is apparent from a comparison of FIGS. 7 and 14. In the fully locked position in FIG. 7, there is no clearance to allow axial movement of the collet 25. However, as shown in FIG. 14, the collet is free to move axially. In practice, therefore, in the first example, little or no axial movement of the tube T is possible in the fully locked position. By contrast, in FIG. 14, any attempt to remove the tube T proximally from the connector will cause a small amount of axial movement of the collet 25 as its teeth 31 grip the tube T. After a small amount of axial movement, the heads 30 of the collet 25 engage with the cap angle 33′ and will grip the tube T more firmly as described previously. The clearance provided by the enlarged cap angle 33′ is also sufficient to allow the tube T to be removed without screwing the cap 23′.

As shown in FIG. 16, the insertion of the release tool 40 is done in the same way as in the first example. As previously, the release tool 40 will deflect the heads 30 radially outwardly as well as preventing proximal axial movement of the collet 25, thereby ensuring that the cap angle 33′ does not cause deflection of the legs 28.

A third example of the connector is shown in FIG. 18. This shows a double-ended connector which is similar to the two previously described connectors and the same reference numerals have been used to include the same features.

As will be appreciated from the description of the second example, the need for the cap 23′ being moveable with respect to the body 21 has been removed. Although the cap 23′ does not need to be moved in the second example, it can potentially still be moved in order to provide greater freedom of movement for the collet during the insertion and removal operations described.

However, the third example is one in which the threaded connection 24 has been removed. In this case, a modified body 21″ is designed to have a snap-fit with a modified cap 23″. The body 23″ is provided with a projection 61 which has a proximal ramp face 62 and a distal shoulder 63. The cap 23 has a complimentary shape and has a shoulder 64 which is complimentary to the distal shoulder 63. The cap 23″ is pushed onto the body 21″ such that the ramp face 62 deflects the end of the cap 23″ over the projection 61 until cap 23″ snaps into the position shown in FIG. 18 in which the shoulder 64 on the cap 23″ engages behind the distal shoulder 63 on the body 21″. In this position, the cap 23″ is axially fixed with respect to the body 21″. As an alternative to the snapped connection, the cap may be welded to the body.

Given the lack of axial movement between these two components, the internal geometry of the connector should be in accordance with the second example. In particular, the cap 23″ should have the longer cap angle 33′ as described in relation to the second example.

The manner in which the tube T engages and disengages with the third example, is the same as for the second example and will therefore not be described here.

1. A tube connector to receive and secure a tube, the connector comprising:
a body with a throughway with an open proximal end to receive a tube; an O-ring within the throughway to seal on the wall of the tube;
a collet comprising a collet ring at a distal end of the collet and a plurality of resilient collet legs extending proximally from the ring, the legs having teeth to grip, in use, a tube in the connector;
and a cap fitted to the body to retain the collet, the cap having an opening at the open end to allow entry of the tube and having a cap angle configured to cooperate with the collet legs to push the teeth into engagement with the tube, in use, when the tube is moved proximally;
wherein the opening in the cap has at least one recess to allow insertion, in use, of a release tool in a distal direction between the tube and cap to deflect the collet legs away from the tube.

2. A tube connector according to claim 1, wherein the cap is captive on the body.

3. A tube connector according to claim 1, wherein the collet ring limits the movement of the O-ring.

4. A tube connector according to claim 1, wherein the cap is axially fixed with respect to the body,

5. A tube connector according to claim 1, wherein the collet is axially movable when, in use, the connector receives a tube and is in a fully engaged position.

6. A tube connector according to claim 1, wherein the cap extends proximally beyond the collet.

7. A tube connector according to claim 1, wherein the collet extends into the body.

8. A tube connector according to claim 1, wherein the collet ring is a continuous ring.

9. A tube connector according to claim 1, wherein the collet ring projects radially outwardly with respect to the collet legs.

10. A tube connector according to claim 1, wherein each collet leg has an enlarged head which engages, in use, with the cap angle.

11. A tube connector according to claim 1, wherein the cap only has a single cap angle

12. A tube connector according to claim 1, wherein the only teeth are at the proximal end of the collet.

13. A combination of a tube connector according to claim 1 and a release tool, the release tool being insertable into the connector in a distal direction between the tube and cap to deflect the collet legs away from the tube.

14. A combination of the tube connector according to claim 13, wherein the release tool has a split ring configuration, with sufficient resilience for the tool to be fitted in a radial direction over the tube before being moved axially into the connector.

15. A combination of the tube connector according to claim 13, wherein the release tool has a radially extending flange portion providing a bearing surface via which a user can, in use, push the tool axially into the connector and an engagement portion extending axially from the flange to enter the connector.

16. A combination of the tube connector according to claim 13, wherein the engagement portion comprises a plurality of engagement elements arranged circumferentially, and wherein the connector requires each of the engagement elements to be inserted in order to allow release of the tube.

17. A combination of the tube connector according to claim 13, wherein, in an unstressed state and at its greatest circumferential extent, the tool extends through an angle of at least 270 degrees.

18. A combination of the tube connector according to claim 13, wherein the tool has a chamfered end face which is complementary with a chamfered end face of the collet legs.

19. A release tool for a connector, the tool having a split ring configuration surrounding a central opening, wherein in an unstressed state and at its greatest circumferential extent the tool extends through an angle of at least 270 degrees, defining a gap in the split ring, the tool having sufficient resilience that the gap can be widened to at least the diameter of the central opening;
wherein the release tool has a radially extending flange portion providing a bearing surface via which a user can, in use, push the tool axially and an engagement portion comprising a plurality of engagement elements arranged circumferentially and extending axially from the flange.

20. A release tool according to claim 19, wherein in an unstressed state and at its greatest circumferential extent the tool extends through an angle of at least 280 degrees, at least 290 degrees, at least 300 degrees, at least 310 degrees, at least 320 degrees, or at least 330 degrees.

21. A release tool according to claim 19, wherein the flange has a plurality of through slots positioned circumferentially between the engagement elements and extending radially outwards from the inner periphery of the flange.

22. A release tool according to claim 19, wherein the diameter of the flange is at least twice the diameter of the central opening.

23. A release tool according to claim 19, wherein the tool has a chamfered end face which is complementary with a chamfered end face of the collet legs.
